(19) United States
(12) Patent Application Publication
(10) Pub. No.: US 2023/0062657 A1
(43) Pub. Date: Mar. 2, 2023

(54) SANDWICH MAKER

(71) Applicant: MOU-LI LIN, TAINAN CITY (TW)

(72) Inventor: MOU-LI LIN, TAINAN CITY (TW)

(21) Appl. No.: 17/460,496

(22) Filed: Aug. 30, 2021

(51) Int. Cl. A47J 37/06

(52) U.S. Cl. CPC A47J 37/0611

(57) ABSTRACT

A sandwich maker includes a lower baking plate, a middle plate, an upper baking plate, and a baking ring. When the baking ring is coupled to the middle plate in a non-pivot manner, a first space is defined by the baking ring together with the middle plate and the lower baking plate, and a second space is defined by the baking ring together with the middle plate and the upper baking plate. When the baking ring is pulled away from the middle plate, the first space communicates with the second space, so that the ingredients can be directly combined into a sandwich after cooking.

### FIELD OF THE INVENTION

The present invention relates to a sandwich maker, and more particularly to a sandwich maker that can cook different ingredients separately and directly combine all the ingredients to form a sandwich after cooking.

### BACKGROUND OF THE INVENTION

A sandwich is an item of food consisting of two pieces of toast with meat, jelly, cheese, or other filling between them. Because a sandwich is quick and easy to prepare, it is one of the foods chosen for family outings or company meetings.

However, taking a heated toast sandwich as an example, if the toast sandwich is sandwiched with an egg or meat, in order to cook the egg or meat without burning the toast, it is necessary to prepare the toast and the egg/meat separately. After the toast is heated and the egg/meat is cooked, the toast and the egg/meat are assembled manually to form a complete sandwich. If the number of sandwiches to be prepared is large, the preparer may be in a rush and a muddle.

US patent Publication No. U.S. Ser. No. 09/370,275B2 provides a sandwich making appliance, which mainly comprises a bottom housing, a top housing and a ring assembly. The ring assembly includes a top ring, a bottom ring and a center cooking plate to divide a space defined by the ring assembly into two cooking cavities, so that the ingredients can be cooked separately in the same sandwich maker. By pivoting the center cooking plate, the top ring and the bottom ring can be pivoted apart, so that the ingredients are combined into a sandwich.

In the aforementioned patent, although the top ring and the bottom ring can be pivoted apart for the ingredients to be combined into a sandwich on the outside of the bottom housing and the top housing. However, since the top ring and the bottom ring are still connected to the other structures of the sandwich making appliance, if the user wants to take the sandwich to another place, he/she needs to move it together with the entire sandwich making appliance, or to remove the sandwich from the upper ring and the lower ring. At this time, the sandwich loses support and tends to tilt. When the internal ingredients are loose, they may be scattered during the movement.

### SUMMARY OF THE INVENTION

The primary object of the present invention is to provide a sandwich maker, comprising a lower baking plate; a middle plate, adjacent to the lower baking plate, the middle plate being pivotable relative to the lower baking plate through a pivot member provided on one side of the middle plate; an upper baking plate, adjacent to the middle plate, the upper baking plate being pivotable relative to the lower baking plate and the middle plate; and a baking ring, detachably coupled to the middle plate in a non-pivot manner, the baking ring having a handle spaced away from the pivot member. When the baking ring is coupled to the middle plate, the baking ring is located between the lower baking plate and the upper baking ring, a first space is defined by the baking ring together with the middle plate and the lower baking plate, and a second space is defined by the baking ring together with the middle plate and the upper baking plate; in this state, the second space does not connect with the first space. However, when the baking ring is pulled away from the pivot member in a linear direction through the handle, the baking ring is separated from the middle plate, and responsive to the baking ring being completely separated from the lower baking plate and the upper baking, the first space connects with the second space.

According to the above technical features, the following effects can preferably be achieved:

1. In the process of moving the sandwich, the sandwich is still shaped by the lower baking ring and the upper baking ring that can be completely separated from the sandwich maker, so that the sandwich can be kept in the best appearance until it is eaten.

2. With the middle plate, the space inside the baking ring can be separated into the first space and the second space during cooking, so that the first piece of toast at the bottom of the sandwich can be cooked separately from other ingredients. After the cooking is completed, the baking ring is removed in a non-pivot manner, so that the first space connects with the second space for all the ingredients to be directly combined into a sandwich.

While taking out the baking ring, a dish is placed under the baking ring, and the sandwich is directly placed on the dish. There is no need to use another tool to remove the sandwich from the lower baking plate, which is convenient for eating.

### BRIEF DESCRIPTION OF THE DRAWINGS

FIG. 1 is a front perspective view according to a first embodiment of the present invention;

FIG. 2 is a rear perspective view according to the first embodiment of the present invention;

FIG. 3 is an exploded view according to the first embodiment of the present invention;

FIG. 4 is a partially sectional view according to the first embodiment of the present invention:

FIG. 5 is a first schematic view according to the first embodiment of the present invention, illustrating that a first piece of toast is placed into the lower baking ring;

FIG. 6 is a second schematic view according to the first embodiment of the present invention, illustrating that an egg is cracked on the middle plate and then second piece of toast is placed;

FIG. 7 is a first cross-sectional view of the first embodiment of the present invention when in use, illustrating that the first piece of toast is separated from the egg;

FIG. 8 is a third schematic view according to the first embodiment of the present invention, illustrating that the upper baking plate and the lower baking plate are pulled outwardly:

FIG. 9 is a fourth schematic view according to the first embodiment of the present invention, illustrating that the upper baking plate and the lower baking plate are pulled out of the sandwich maker to complete the sandwich;

FIG. 10 is a second cross-sectional view of the first embodiment of the present invention when in use, illustrating that the middle plate is removed;

FIG. 11 is a third cross-sectional view of the first embodiment of the present invention when in use, illustrating that the upper housing is opened;

FIG. 12 is a fourth cross-sectional view of the first embodiment of the present invention when in use, illustrating that the second pivot rod of the middle plate naturally comes out of the notch;

FIG. 13 is a fifth cross-sectional view of the first embodiment of the present invention when in use, illustrating that the middle plate is completely separated from the upper housing;

FIG. 14 is an exploded view according to a second embodiment of the present invention;

FIG. 15 is a perspective view according to the second embodiment of the present invention; and

FIG. 16 is a schematic view of the second embodiment of the present invention when in use, illustrating that the first hamburger bun, the egg, and the second hamburger bun form a sandwich.

### DESCRIPTION OF THE PREFERRED EMBODIMENTS

Embodiments of the present invention will now be described, by way of example only, with reference to the accompanying drawings.

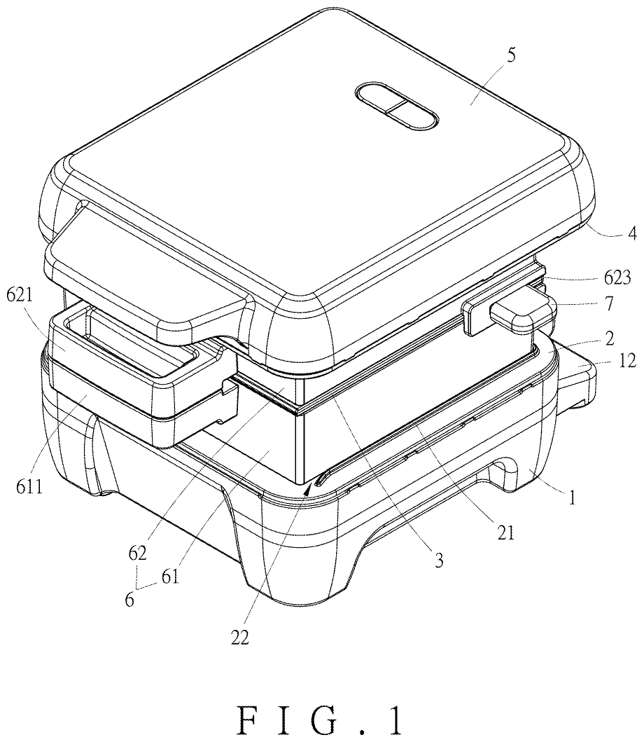

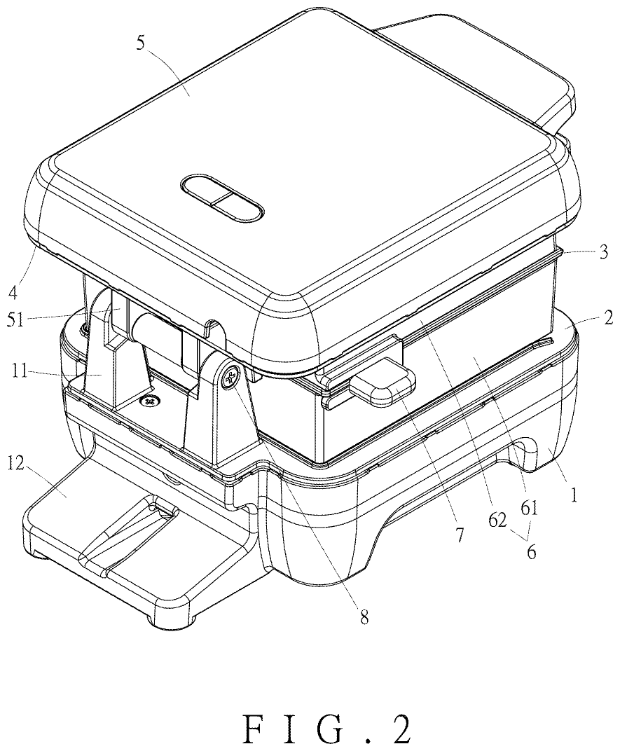

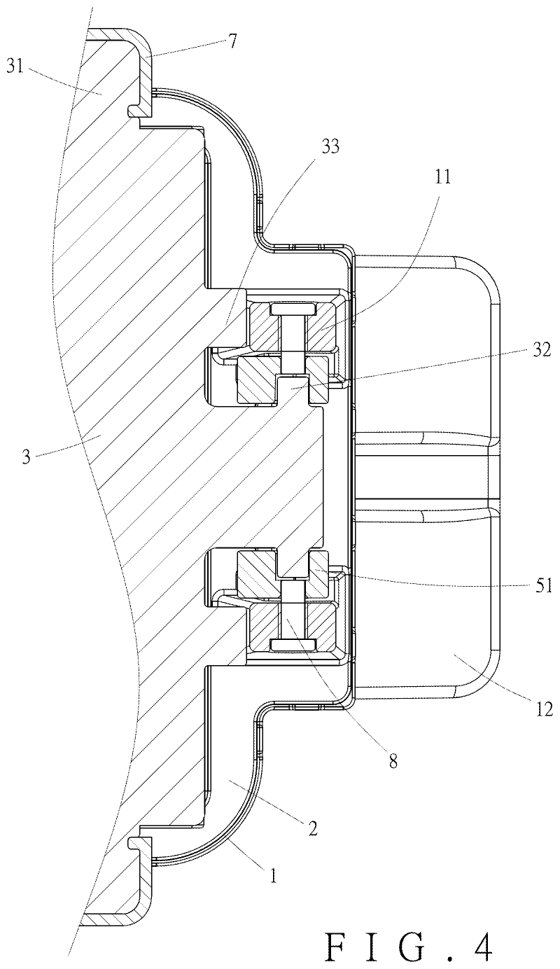

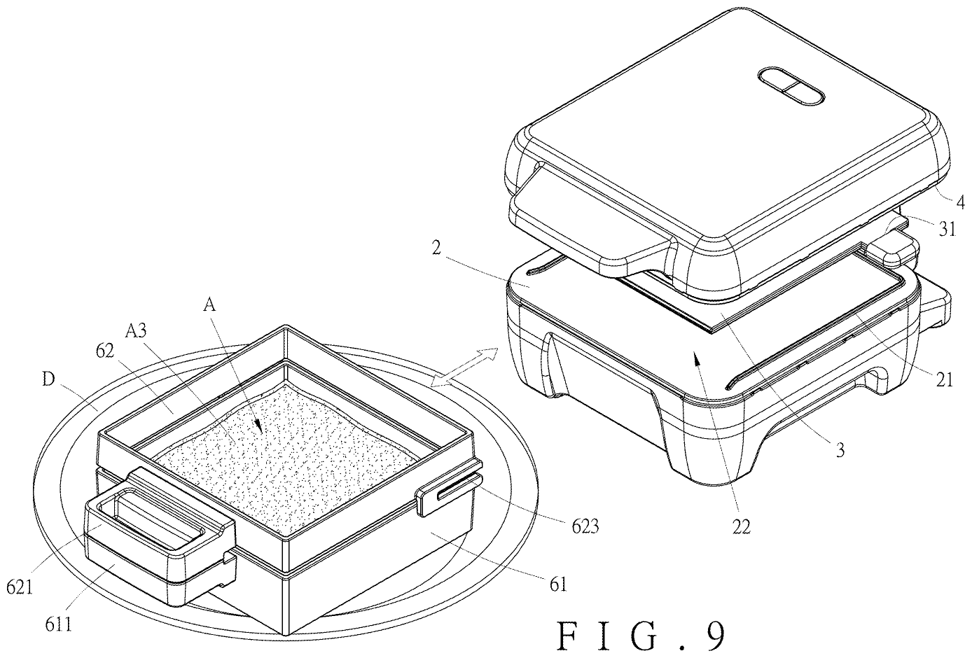

Referring to FIG. 1 through FIG. 4, a sandwich maker, used for making a sandwich A (referring to FIG. 9), according to a first embodiment of the present invention comprises a lower housing 1, a lower baking plate 2, a middle plate 3, an upper baking plate 4, an upper housing 5, a baking ring 6, and a heat insulation ring 7. In this embodiment, the lower housing 1 and the upper housing 5 are pivotally connected to each other. The lower baking plate 2 and the upper baking plate 4 are coupled to the opposing surfaces of the lower housing 1 and the upper housing 5, respectively. Both the baking ring 6 and the middle plate 3 are located between the lower baking plate 2 and the upper baking plate 4.

More specifically, one side of the lower housing 1 has a first pivot portion 11, and one side of the upper housing 5 has a second pivot portion 51. The second pivot portion 51 has a notch 511. The first pivot portion 11 and the second pivot portion 51 of the lower housing 1 and the upper housing 5 are pivotally connected to each other by a first pivot rod 8, so that the upper baking plate 4 and the lower baking plate 2 can be relatively pivoted along with the upper housing 5 and the lower housing 1, respectively. A support portion 12 protrudes from the lower housing 1. The support portion 12 is adjacent to the first pivot portion 11 and extends away from the lower baking plate 2.

Each of the outer edges of the opposite sides of the middle plate 3 has a slide block 31. One end of the middle plate 3 has a second pivot rod 32 as a pivot member, and has an abutting block 33 adjacent to the second pivot rod 32. The second pivot rod 32 is pivotally connected to the second pivot portion 51 of the upper housing 5 to pivot relative to the upper housing 5 and the lower housing 1. The width of the notch 511 of the second pivot portion 51 is between a maximum width and a minimum width of the second pivot rod 32. In actual implementation, the second pivot rod 32 may be pivotally connected to the first pivot portion 11 of the lower housing 1. The slide block 31 is a block for the heat insulation ring 7 to be sleeved onto the block.

A guide rib 21 protrudes from either side of the lower baking plate 2 corresponding to the baking ring 6. The guide rib 6 defines a linear direction. A guide opening 22 between the guide ribs 21 on both sides of the lower baking plate 2 is disposed away from the second pivot rod 32.

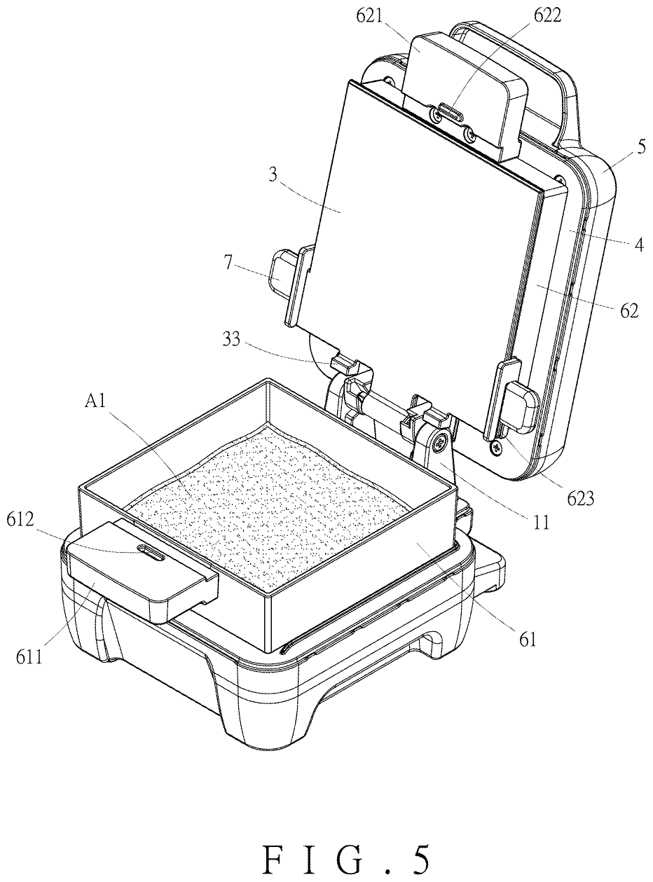

The baking ring 6 is detachably coupled to the middle plate 3 in a non-pivot manner. In more detail, the baking ring 6 includes a lower baking ring 61 and an upper baking ring 62 adjacent to each other. The lower baking ring 61 has a first handle 611, and the upper baking ring 62 has a second handle 621. Both the first handle 611 and the second handle 621 are spaced away from the second pivot rod 32. The first handle 611 has an engaging groove 612, and the second handle 621 has a engaging block 622 corresponding to the engaging groove 612 (referring to FIG. 5). When the engaging block 622 is engaged with the engaging groove 612, the lower baking ring 61 and the upper baking ring 62 are linked with each other. The opposite sides of the upper baking ring 62 are provided with slide grooves 623. The opening of the slide groove 623 faces the second pivot rod 32. When the baking ring 6 is slidably coupled to the middle plate 3, the slide blocks 31 of the middle plate 3 are engaged in the slide grooves 623, respectively.

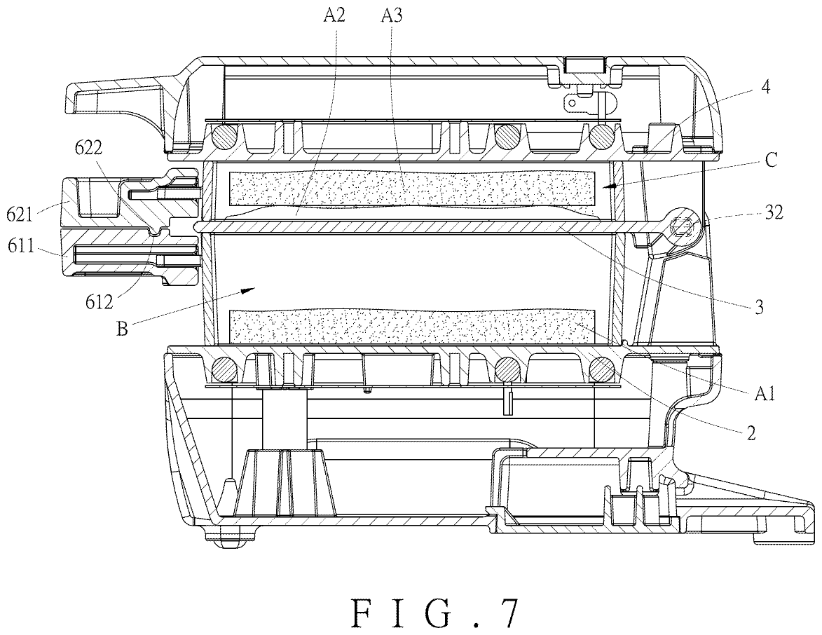

When the baking ring 6 is coupled to the middle plate 3, the lower baking ring 61 is located between the middle plate 3 and the lower baking plate 2, and the upper baking ring 62 is located between the middle plate 3 and the upper baking plate 4. As a result, a first space B is defined by the lower baking ring 61 together with the middle plate 3 and the lower baking plate 2, and a second space C is defined by the upper baking ring 62 together with the middle plate 3 and the upper baking plate 4. In this state, the second space C does not communicate with the first space B, referring to FIG. 7.

In actual implementation, the upper baking plate 4 and the lower baking plate 2 are electrically connected to an external socket and include a tubular electric heating element serving as the heat source of the sandwich maker. The sandwich maker may be provided with a switch (not shown) for controlling the heating of the upper baking plate 4 and the lower baking plate 2.

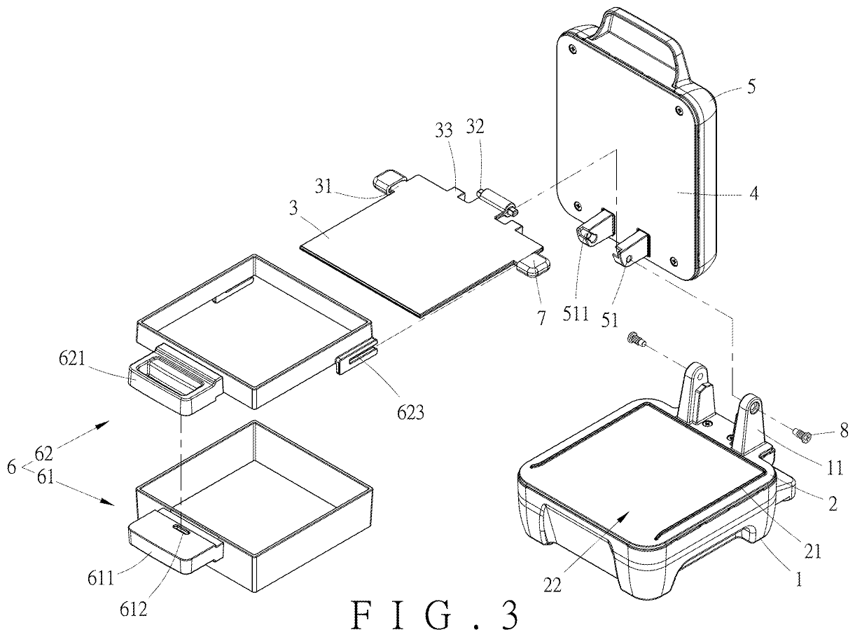

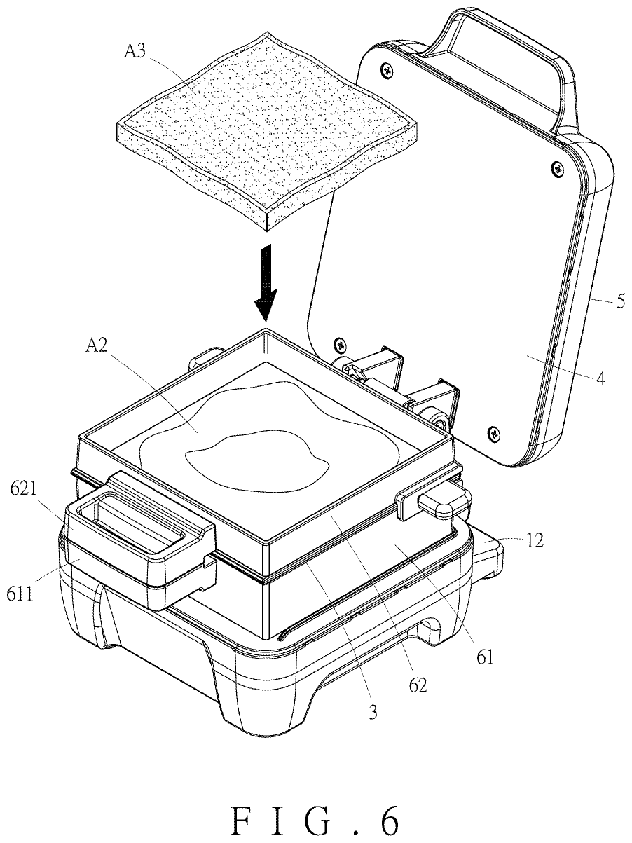

Please refer to FIG. 3, FIG. 5 and FIG. 6. When the sandwich maker is to be used, the lower baking ring 61 and the upper baking ring 62 are inserted between the upper baking plate 4 and the lower baking plate 2 from the guide opening 22 along the guide ribs 21 in the linear direction to be coupled to the middle plate 3, and the slide blocks 31 of the middle plate 3 are engaged in the slide grooves 623 of the upper baking ring 62, respectively.

Then, the middle plate 3 is pivoted together with the upper baking ring 62, and the upper housing 5 is driven to open. After the middle plate 3 is pivoted, the abutting block 33 abuts against the first pivot portion 11 so that the middle plate 3 stays in an open position. Since the support portion 12 provides a stable support for the sandwich maker, there is no need to worry about the sandwich maker to incline due to the weight concentrated on one side of the first pivot portion 11 when the middle plate 3 is opened.

At this time, the first piece of toast A1 is placed on the lower baking plate 2 so that the first toast A1 is located in the first space B of the lower baking ring 61, referring to FIG. 7.

Please refer to FIG. 3, FIG. 6 and FIG. 7. The middle plate 3 is pivoted downwardly together with the upper baking ring 62, so that the middle plate 3 and the upper baking ring 62 cover the lower baking ring 61.

Then, the user can crack an egg A2 in the upper baking ring 62 and place a second piece of toast A3. The egg A2 and the second piece of toast A3 are on the middle plate 3 and located in the second space C of the upper baking ring 62. Due to the guide ribs 21, the baking ring 6 can be accurately guided, positioned and aligned with the middle plate 3, avoiding a gap formed between the middle plate 3 and the baking ring 6 to result in a situation that the ingredient, such as the egg A2, seeps out from the gap.

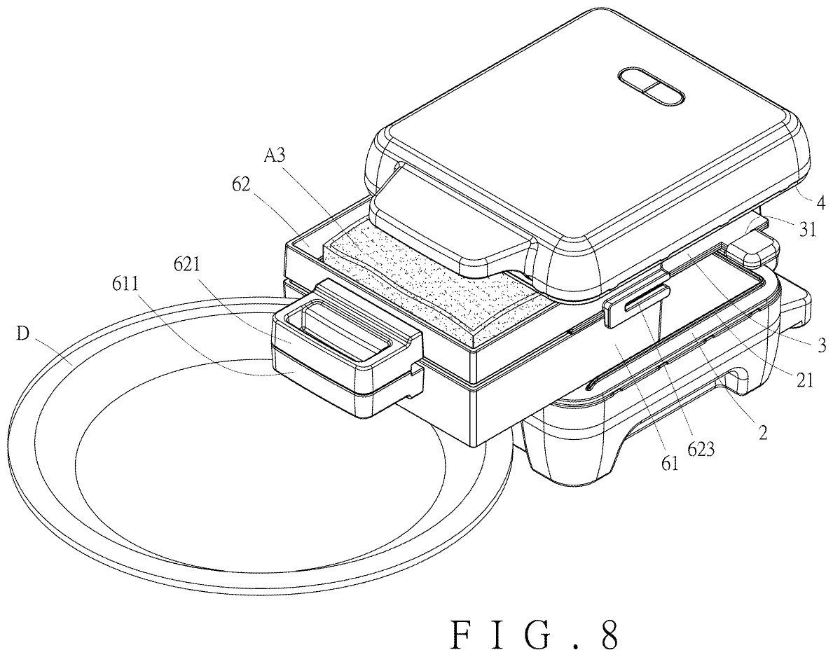

Referring to FIGS. 7-9, the upper housing 5 is pivoted downwardly, and the power of the sandwich maker is turned on for heating.

The user can check the cooking situation by opening the upper housing 5. When the cooking is completed, the user can hold the first handle 611 and the second handle 621, and the upper baking ring 62 and the lower baking ring 61 are horizontally pulled in the linear direction away from the second pivot rod 32, so that the upper baking ring 62 and the lower baking ring 61 are separated from the middle plate 3. Responsive to the upper baking ring 62 and the lower baking ring 61 being completely separated from the lower baking plate 2 and the upper baking plate 4, the first space B connects with the second space C.

While taking out the upper baking ring 62 and the lower baking ring 61, a dish D is placed under the lower baking ring 61. At this time, without the support of the middle plate 3 and the lower baking plate 2, the first piece of toast A1, the egg A2, and the second piece of toast A3 fall down and are directly combined into a sandwich A in the dish D. There is no need to use another tool to remove the sandwich A from the lower baking plate 2, which is convenient for eating.

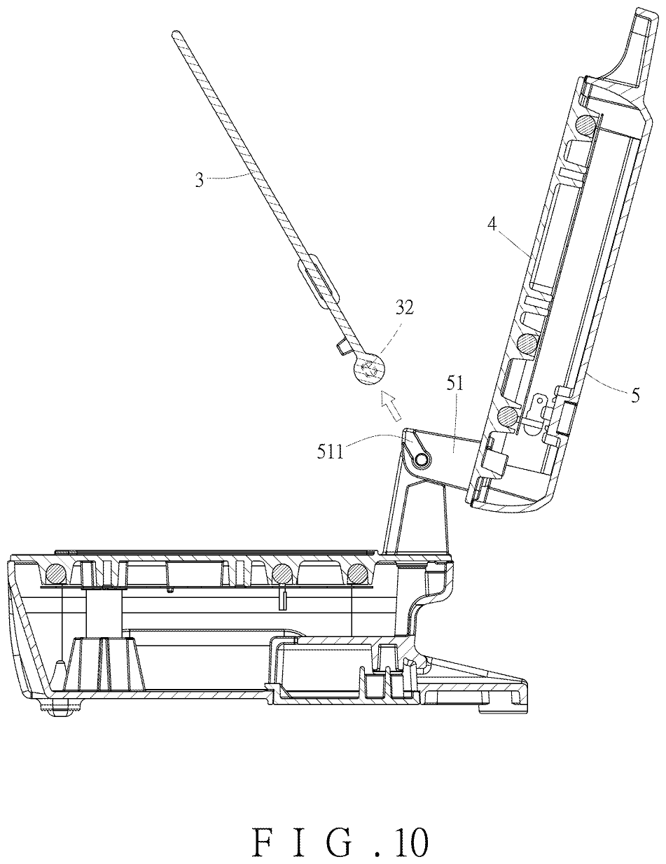

Referring to FIG. 3 and FIG. 10, when the middle plate 3 is to be removed for cleaning the sandwich maker, the middle plate 3 is pivoted so that the second pivot rod is moved to a position with its minimum width edge corresponding to the notch 511. At this time, because the upper housing 5 is opened and the notch 511 obliquely faces upward, the user can move the middle plate 3 obliquely upwards toward the notch 511, so that the second pivot rod 32 is moved out of the second pivot portion 51 from the notch 511, thereby separating the middle plate 3 from the upper baking plate 4 for cleaning the middle plate 3 separately.

Because the middle plate 3 is provided with the heat insulation rings 7, it is convenient for the user to grasp the heat insulation rings 7 and remove the middle plate 3. After the middle plate 3 is removed, the user can place the middle plate 3 on a tabletop through the heat insulation rings 7 without worrying that the high-temperature middle plate 3 may damage the tabletop or burn the user's hand.

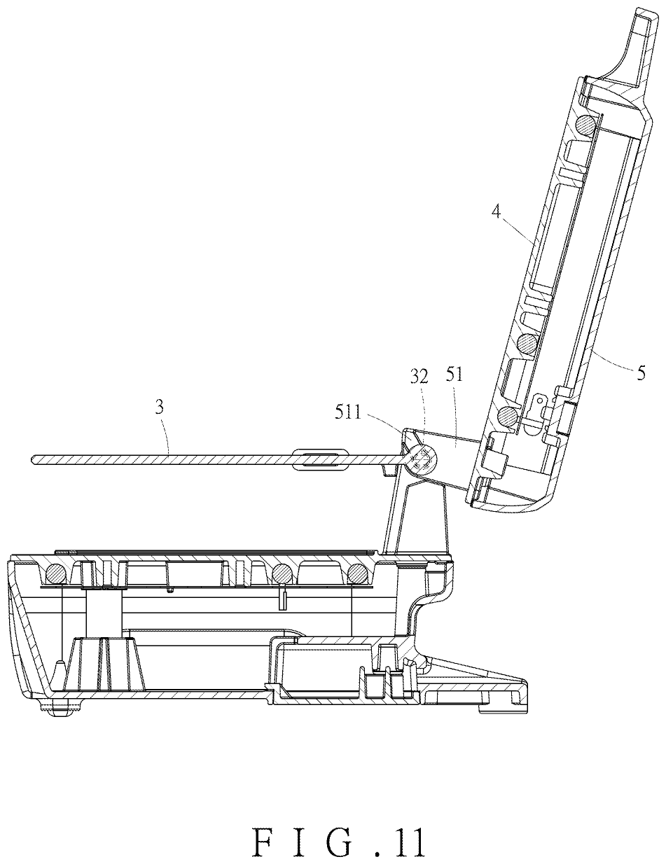

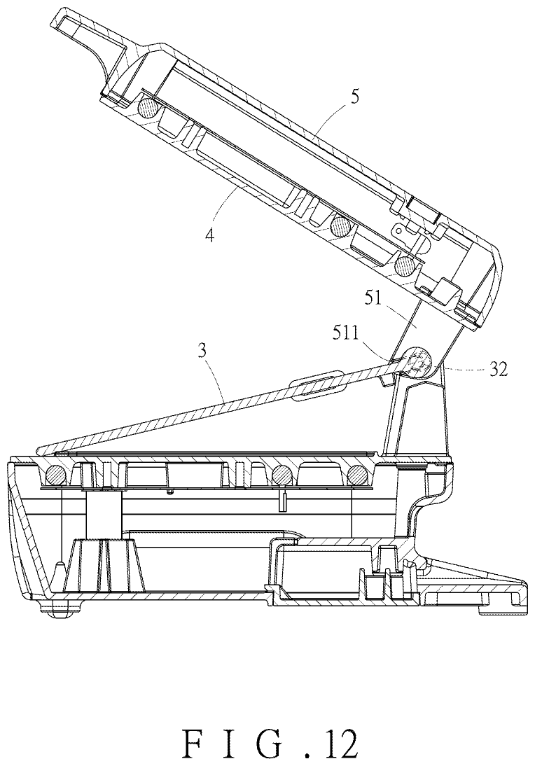

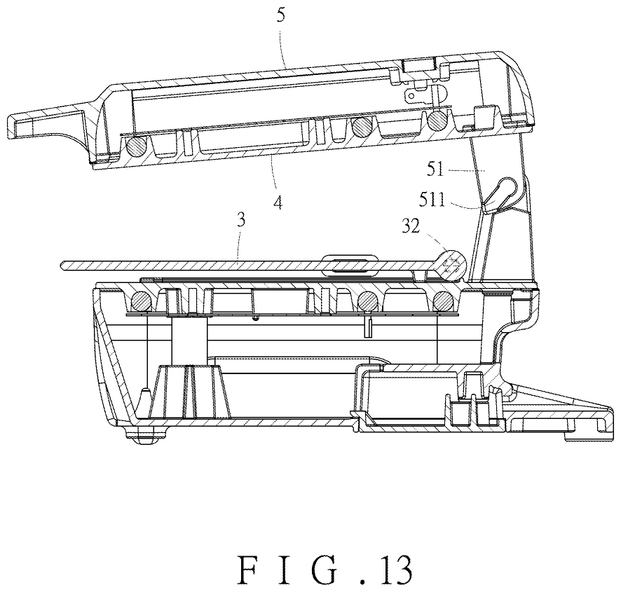

Please refer to FIGS. 11-13. In addition to the user grasping the heat insulation rings 7, as shown in FIG. 10, to directly remove the middle plate 3 from the upper housing 5, the middle plate 3 may be removed in other ways.

Preferably, in a situation that the upper housing 5 is opened, the upper housing 5 is pivotally closed. In the pivoting process, the minimum width edge of the second pivot rod 32 corresponds to the notch 511. At this time, because the middle plate 3 is not supported by the lower baking plate 2 (referring to FIG. 9), the middle plate 3 is subject to its own gravity. When the upper housing 5 is closed, the notch 511 obliquely faces downward, and the second pivot rod 32 will naturally come out of the notch 511, so that the middle plate 3 and the upper housing 5 are completely separated. There is no need for the user to pull the middle plate 3. The middle plate 3 is directly removed from the upper housing 5 for cleaning the middle plate 3 separately.

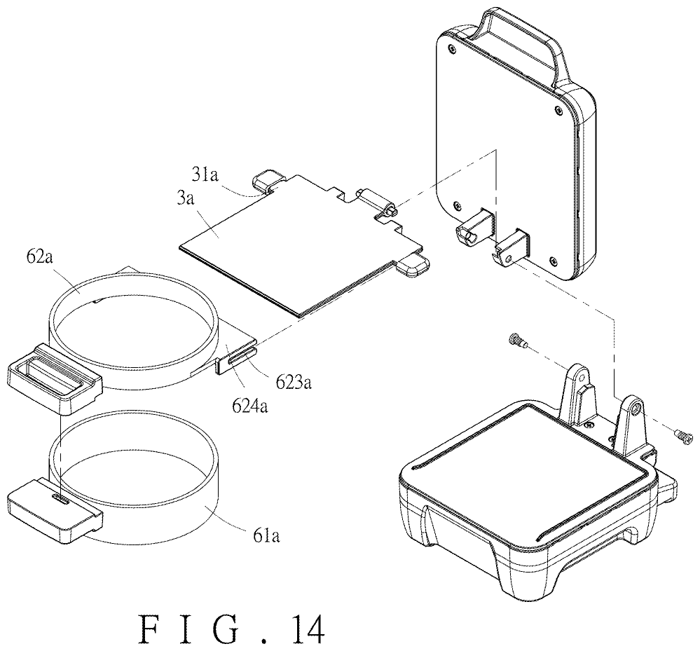

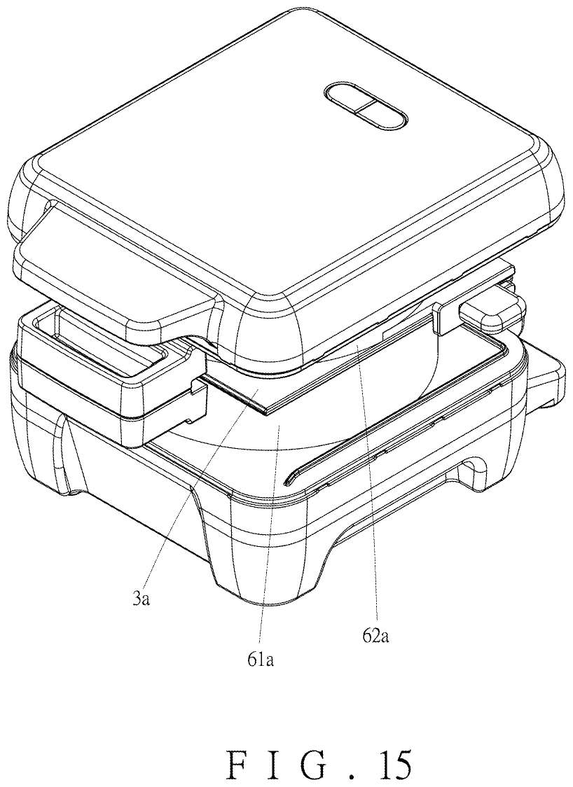

FIGS. 14-16 disclose a second embodiment of the sandwich maker of the present invention. The second embodiment is substantially similar to the first embodiment with the exceptions described hereinafter. In the first embodiment, referring to FIG. 7 and FIG. 9, the lower baking ring 61 and the upper baking ring 62 each have a square shape, so that the first embodiment is more suitable for the first piece of toast A1 and the second piece toast A2 with a square shape. In the second embodiment, the lower baking ring 61 and the upper baking ring 62 each have a circular shape, so that the second embodiment is more suitable for round ingredients, such as, the first piece of toast A1 and the second piece toast A2 that are cut into a circle in advance, English muffins, etc.

Preferably, a wing 624a protrudes from the outer edge of the upper baking ring 62a, and the wing 624a is formed with the slide groove 623a for correspondingly engaging with the slide blocks 31a of the middle plate 3a.

In this embodiment, a first hamburger bun, the egg and a second hamburger bun E 1 constitute the sandwich E. The egg is also shaped into a round shape by the upper baking ring 62a. However, only the second hamburger bun E1 at the uppermost layer is shown in the figures.

With the middle plate 3a, the first hamburger bun, the egg and the second hamburger bun E1 are cooked separately. After the lower baking ring 61a and the upper baking ring 62a are pulled out, the first hamburger bun, the egg and the second hamburger bun E1 directly form the complete sandwich E on the dish D. The other structures and cooking steps of this embodiment are the same as those of the first embodiment, and will not be repeated hereinafter.

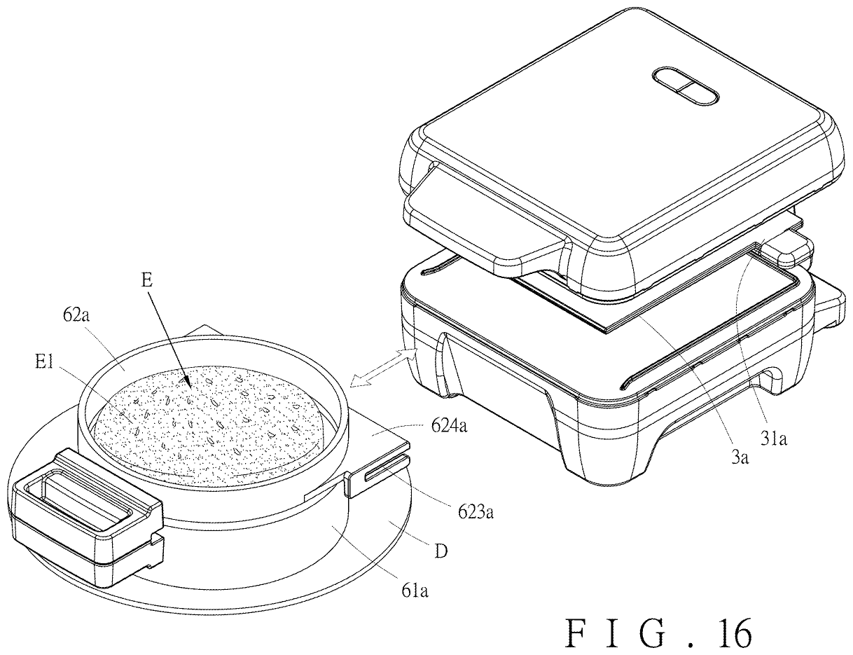

Referring to FIG. 9 and FIG. 16, the different shapes of the lower baking ring 61, 61a and the upper baking ring 62, 62a can be applied to different ingredients of the sandwich A, E and improve the convenience of use of the sandwich maker.

With the middle plates 3, 3a, the ingredients of the sandwich A, E can be cooked separately during cooking. After cooking, only the lower baking ring 61, 61a and the upper baking ring 62, 62a are removed in a non-pivot manner, and then all the ingredients can be directly combined into the sandwich A, E.

In addition, by completely removing the lower baking ring 61, 61a and the upper baking ring 62, 62a, the user can directly use the dish D together with the lower baking ring 61, 61a and the upper baking ring 62, 62a to move the sandwich A, E together. In the process of moving the sandwich A E, the sandwich A, E is still shaped by the lower baking ring 61, 61a and the upper baking ring 62, 62a. The sandwich A, E can be kept in the best appearance until it is eaten.

Since the upper baking rings 62, 62a have the slide grooves 623, 623a, the lower baking rings 61, 61a and the upper baking rings 62, 62a of different shapes can be directly replaced according to the needs. For example, on the first day, the lower baking ring 61 and the upper baking ring 62 of the first embodiment of the sandwich maker are used to make the sandwich A. On the next day, the lower baking ring 61a and the upper baking ring 62a of the second embodiment of the sandwich maker are directly mounted to the middle plate 3 of the first embodiment to make the sandwich E. There is no need to purchase another sandwich maker.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A sandwich maker, comprising:
a lower baking plate;
a middle plate, adjacent to the lower baking plate, the middle plate being pivotable relative to the lower baking plate through a pivot member provided on one side of the middle plate;
an upper baking plate, adjacent to the middle plate, the upper baking plate being pivotable relative to the lower baking plate and the middle plate; and
a baking ring, detachably coupled to the middle plate in a non-pivot manner, the baking ring having a handle spaced away from the pivot member;
wherein when the baking ring is coupled to the middle plate, the baking ring is located between the lower baking plate and the upper baking ring, a first space is defined by the baking ring together with the middle plate and the lower baking plate, and a second space is defined by the baking ring together with the middle plate and the upper baking plate, and the second space does not connect with the first space;
wherein when the baking ring is pulled away from the pivot member in a linear direction through the handle, the baking ring is separated from the middle plate, and responsive to the baking ring being completely separated from the lower baking plate and the upper baking, the first space connects with the second space.

2. The sandwich maker as claimed in claim 1, wherein the baking ring includes a lower baking ring and an upper baking ring adjacent to each other; when the baking ring is coupled to the middle plate, the lower baking ring is located between the middle plate and the lower baking plate, the upper baking ring is located between the middle plate and the upper baking plate, the first space is defined by the lower baking ring together with the middle plate and the lower baking plate, and the second space is defined by the upper baking ring together with the middle plate and the upper baking plate.

3. The sandwich maker as claimed in claim 2, the lower baking ring and the upper baking ring each have the handle, the handle of one of the lower baking ring and the upper baking ring has an engaging block, the handle of the other of the lower baking ring and the upper baking ring has an engaging groove corresponding to the engaging block; the engaging block is engageable with the engaging groove, thereby enabling the lower baking ring and the upper baking ring to be linked together.

4. The sandwich maker as claimed in claim 1, wherein an outer edge of the middle plate has a first coupling portion, the baking ring has a second coupling portion; when the baking ring is coupled to the middle plate, the first coupling portion and the second coupling portion are correspondingly coupled, thereby enabling the middle plate and the baking ring to be linked together.

5. The sandwich maker as claimed in claim 4, wherein the first coupling portion is a slide block, the second coupling portion is a slide groove, an opening of the slide groove faces the pivot member, and the baking ring is slidably coupled to the middle plate.

6. The sandwich maker as claimed in claim 4, wherein the baking ring includes an upper baking ring, and the second coupling portion is located on the upper baking ring; when the baking ring is coupled to the middle plate, the upper baking ring is located between the middle plate and the upper baking plate.

7. The sandwich maker as claimed in claim 1, wherein a block extends from an outer edge of the middle plate, and a heat insulation ring is sleeved on the block.

8. The sandwich maker as claimed in claim 1, wherein a guide rib protrudes from either side of the lower baking plate corresponding to the baking ring, the guide rib defines the linear direction, and a guide opening between the guide ribs on both sides of the lower baking plate is disposed away from the pivot member.

9. The sandwich maker as claimed in claim 1, further comprising a lower housing and an upper housing that are pivotally connected to each other through a first pivot portion and a second pivot portion, wherein the upper baking plate and the lower baking plate are coupled to opposing surfaces of the upper housing and the lower housing respectively, and the pivot member of the middle plate is pivotally connected to the first pivot portion and/or the second pivot portion.

10. The sandwich maker as claimed in claim 9, further comprising a first pivot rod, wherein the first pivot portion and the second pivot portion are pivotally connected to each other through the first pivot rod, the pivot member of the middle plate is defined as a second pivot rod and is pivotally connected to the second pivot portion; the second pivot portion has a notch, the notch has a width between a maximum width and a minimum width of the second pivot rod; by pivoting the middle plate, the second pivot rod is moved to a position with its minimum width edge corresponding to the notch so that, after the middle plate is further moved outward through the notch, the second pivot rod comes out of the second pivot portion from the notch, thereby separating the middle plate from the upper baking plate and the lower baking plate.

11. The sandwich maker as claimed in claim 10, wherein when the upper housing is opened, the notch obliquely faces upward; when the upper housing is closed, the notch obliquely faces downward.

12. The sandwich maker as claimed in claim 9, wherein the middle plate has an abutting block adjacent to the pivot member; after the middle plate is pivoted, the abutting block abuts against the first pivot portion so that the middle plate stays in an open position.

13. The sandwich maker as claimed in claim 9, wherein a support portion protrudes from the lower housing, and the support portion is adjacent to the first pivot portion and extends away from the lower baking plate.
